(19) United States
(12) Patent Application Publication
(10) Pub. No.: US 2006/0164239 A1
(43) Pub. Date: Jul. 27, 2006

(54) Shipping container and method of using same

(76) Inventor: David C. Loda, Bolton, CT (US)

Correspondence Address: BACHMAN & LAPOINTE, P.C. (P&W), 900 CHAPEL STREET, SUITE 1201, NEW HAVEN, CT, 06510-2802, US

(21) Appl. No.: 10/541,927

(22) PCT Filed: Jan. 14, 2004
(86) PCT No.: PCT/US04/00814

§ 371 Date: Jul. 12, 2005

Related U.S. Application Data
(60) Provisional application No. 60/319,868, filed on Jan. 14, 2003.
(60) Provisional application No. 60/320,004, filed on Mar. 12, 2003.

(51) Int. Cl. G08B 1/08; G08B 13/18; G08B 21/00

(52) U.S. Cl. 340/539.22; 340/539.26; 340/652; 340/552

(57) ABSTRACT

A shipping container for detecting conditions of the container from a remote location, or sensing the condition of other shipping containers within the vicinity of the shipping container, is disclosed. The shipping container may include an onboard microserver communicating with a plurality of sensors within the container. The microserver may serve as an Internet node enabling sensed conditions within the container to be communicated to remote computing devices by way of the Internet. The shipping container also may include anti-tampering equipment such as a conductive grid such that any tampering with the container will necessarily effect an electrical parameter of the grid with the change in the electrical parameter then being detected and causing an alarm or other corrective measure to be taken.

### CROSS REFERENCE TO RELATED APPLICATION

This application is a non-provisional patent application claiming the priority benefits under 35 U.S.C. §119(e) of U.S. Provisional Patent Application Ser. No. 60/319,868, filed on Jan. 14, 2003, and U.S. Provisional Patent Application Ser. No. 60/320,004, filed on Mar. 12, 2003, and is related to U.S. Provisional Patent Application Ser. No. 60/337,926, filed on Dec. 3, 2001 and U.S. patent application Ser. No. 10/155,593, filed on May 22, 2002, all of which are herein incorporated by reference.

### FIELD OF THE INVENTION

This disclosure generally relates to shipping containers and, more specifically, relates to shipping containers having onboard electronics.

### BACKGROUND OF THE DISCLOSURE

In the transportation industry, significant costs are incurred when cargo or containers carrying the cargo are damaged, stolen, tampered with, or otherwise detrimentally altered. With the shipping of expensive equipment such as aircraft engines and/or perishable goods such as food, the loss of the cargo of only a single container could result in significant monetary losses. Such losses could result from a failed refrigeration unit, theft, tampering, accidents, and the like. However, depending on the location of the shipping container at the time, it may be many hours or days before the damage is detected. For example, the container may be one of hundreds on board a cargo ship or freight train. As such vehicles are often out to sea or en route for days at a time, the condition of the cargo may go for long periods of time without inspection. By the time the cargo reaches its destination, it may be too late to save the cargo or effectively investigate the mishap.

In the aforementioned applications, various global wireless mobile asset tracking approaches using a wireless architectural approaches are disclosed. Briefly, the approaches use an onboard, distributed computing approach with wireless links to the Internet to provide remote two-way interaction from anywhere on the globe. The approaches center around an onboard Internet microserver (e.g., a low cost, palm-sized LINUX-based work station plugged into the product data bus, formatted as a webserver having multiple means to wirelessly connect to the Internet) and an Internet portal. Such a low cost hardware architectural approach turns each mobile, globally deployed product into a fully functional node on the Internet. The approach can be designed into new OEM equipment or retrofitted onto legacy products. Such microserver approaches greatly leverage existing cell, satellite and wired Internet communications infrastructure to link any user and any mobile asset anywhere, anytime. Binding people and assets together is a powerful, user friendly, easily adaptable Internet portal. The portal can be subdivided into compartmentalized communities to provide secure, need-to-know access to finished information “products”, and tools relating to each asset all via the Internet.

In the context of shipping containers, it would be advantageous if a system were to be provided to enable remote monitoring of the containers with respect to tampering and theft. If such a system were to be provided, the microserver, by way of the Internet, could immediately apprise remote locations to either actuate an alarm of some sort, or at least apprise the carrier of the container of the ongoing intrusion so that corrective measures can be taken.

### SUMMARY OF THE DISCLOSURE

In accordance with one aspect of the disclosure, a shipping container is disclosed which comprises an enclosure for receiving at least one product, a sensor on the enclosure capable of detecting a condition, a server on the enclosure communicating with the sensor, and means for enabling communications between the server and a remote location.

In accordance with another aspect of the disclosure, method of monitoring a shipping container is disclosed which comprises the steps of providing a shipping container having an enclosure, a sensor, a server, and means for enabling communication between the server and a remote location, detecting a condition by way of the sensor, and communicating between the server and the remote location in response to the condition being detected. The condition may be detected during transit between an origin and destination or at the destination whereupon the condition can then be analyzed to determine if it is an unacceptable condition.

In accordance with another aspect of the disclosure, a method of facilitating shipment of a container from an origin to a destination is disclosed which comprises the steps of providing a shipping container, supplying a server on the container with information related to at least one product within the container, communicating between the server and the remote location in response to the information, and determining in response to the information how to handle the shipping container. The communicating step can be performed either during transit between the origin and the destination or at the destination.

In accordance with another aspect of the disclosure, a shipping container for detecting conditions of other shipping containers is disclosed which comprises an enclosure, a sensor on the enclosure for detecting conditions of other shipping containers, a server on the enclosure communicating with the sensor, and means for enabling communication between the server and a remote location.

In accordance with another aspect of the disclosure, a shipping container is disclosed which may comprise an enclosure for receiving at least one product, a conductive grid operatively associated with the enclosure, a power source connected to the conductive grid and adapted to energize the conductive grid, a sensor on the enclosure adapted to monitor conditions associated with the conductive grid, and a server on the enclosure adapted to communicate with the sensor and a location remote from the enclosure.

In accordance with a still further aspect of the disclosure, a method of monitoring a shipping container is disclosed which comprises the steps of energizing a conductive grid provided within an enclosure, sensing a condition associated with the conductive grid, communicating the sensed condition to a server associated with the enclosure, and wirelessly transmitting the sensed condition from the server to a remote location.

In accordance with yet another aspect of the disclosure, a system for detecting an intrusion into a shipping container is disclosed which comprises, an enclosure adapted to receive at least one product, a conductive grid operatively associated with enclosure, a power source connected to the conductive grid and adapted to energize the conductive grid, a sensor on the enclosure adapted to monitor a condition associated with the conductive grid, a server on the enclosure adapted to communicate with the sensor and generate a wireless system about the enclosure, and a remote computing device adapted to wirelessly communicate with the server by way of the Internet.

These and other aspects of the disclosure will become more readily apparent upon reading the following detailed description when taken in conjunction with the accompanying drawings.

### BRIEF DESCRIPTION OF THE DRAWINGS

FIG. 1 is a perspective view, with partial cutaway, of one embodiment of a shipping container constructed in accordance with the teachings of the disclosure;

FIG. 2 is a perspective view of one embodiment of a monitoring system used on the shipping container of FIG. 1;

FIG. 3 is a schematic representation of one embodiment of a network of devices, including several of the shipping containers of FIG. 1;

FIG. 4 is a perspective view of one embodiment of an interior of a shipping container constructed in accordance with the teachings of the disclosure;

FIG. 5 is a perspective view of a plurality of shipping containers constructed in accordance with one embodiment of the teachings of the disclosure as loaded on to a carrier in communication with the Internet;

FIG. 6 is a perspective view of an interior of an alternative embodiment of a shipping container constructed in accordance with the teachings of the disclosure; and

FIG. 7 is a flowchart depicting a sample series of steps which may be performed in accordance with one embodiment of the teachings of the disclosure.

While the present disclosure is susceptible to various modifications and alternative constructions, certain illustrative embodiments thereof have been shown in the drawings and will be described below in detail. It should be understood, however, that there is no intention to limit the present disclosure to the specific forms disclosed, but on the contrary the intention is to cover all modifications, alternative constructions, and equivalents falling within the spirit and scope of the present disclosure as defined by the appended claims.

### DETAILED DESCRIPTION OF THE DISCLOSURE

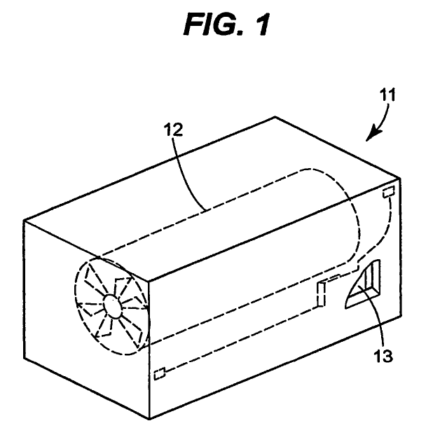

FIG. 1 displays one embodiment of a shipping container 11 constructed in accordance with the teachings of the present disclosure. While preferably a container for a gas turbine engine 12, the shipping container could receive any type of product or any number of products. In fact, the term “shipping container” could refer to any cargo container including, but not limited to, a railroad box car, machine, maritime container, or over-the-road trailer.

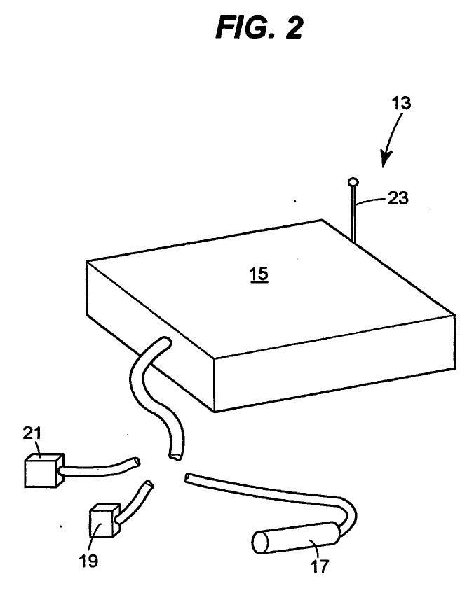

The shipping container 11 includes a monitoring system 13. Although shown as located in the interior, the system 13 could locate at any suitable location on the container 11. FIG. 2 provides a detailed view of the system 13.

The system 13 includes a server 15. The server 15 may monitor the conditions in or near the shipping container 11 and/or gather data about the products within the container 11. To assist such tasks, the server 15 may interact with one or more sensors. As shown in FIG. 2, examples of suitable sensors include a camera 17 (video or still), environmental sensors (e.g., temperature, humidity), chemical sensors, radiological sensors, location sensors (e.g., GPS), accelerometers, smoke detectors, and sensors to detect tampering with the container 11 (e.g., a contact switch 19, to indicate when the container 11 is opened, motion detectors, etc.). The sensors could be hard wired to the server 15, removably connected to the server 15 (e.g. through a USB port) or wirelessly connected to the server.

The server may be programmed in any suitable language to monitor the sensors and/or gather data about the products within the container 11. For example, the server 15 may be used to host a web page that provides information related to the container 11 or the products therein. The server 15 could have the information organized thereon in any suitable format or manner. The server 15 could also include programming to allow diagnostic routines and to allow software updates/upgrades.

Although preferably used by individuals at locations remote from the container 11, the server 15 also allows local individuals to interact therewith through direct connection with a communications port 21 using any desired device (such as a laptop). Alternatively, the local individual could use a wireless device (such as a personal digital assistant (PDA) or personal computer (PC) tablet to interact with the server 15 indirectly with radio frequency (RF) communications or optical links.

The server 15 could be any known computer or processing unit. Preferably, however, the server 15 is a hand-held microserver using a Linux-based operating system. Further, the server 15 may have its own web address, firewall, and security protocols.

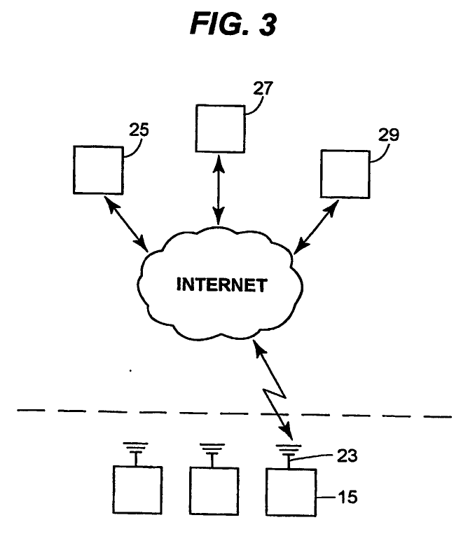

The server 15 preferably includes a device such as an antenna 23 to enable communication between the server and the Internet or world wide web. The antenna 23 could allow cellular, satellite, or wireless communications between the server 15 and the Internet. This allows the server 15 to communicate periodically with the Internet regarding the information obtained from the sensors. This also allows access to the server 15 through the Internet using various devices such as a PC workstation 25, wireless device 27, or network 29, as shown best in FIG. 3.

Alternatively, the present disclosure could allow the use of a portal (not shown) to allow access to the server 15 or certain information thereon. An external server would preferably host the portal. The external server could be any suitable type of server with appropriate communications gear to allow access to and by the server 15.

Although each server 15 preferably communicates separately with the Internet, adjacent servers 15 (such as those being transported by a cargo ship) could create a wireless local area network (LAN). This allows the servers 15 to route communications through one server 15, if desired. Alternatively, the servers 15 could utilize other available outlets, such as the satellite gear of the cargo ship transporting the containers 11, to communicate with the Internet.

A discussion of one possible use of the present invention follows. During the loading of a gas turbine engine 12 in the shipping container 11, the server 15 receives information related to the engine 12. This information could include, for example, the bill of material, customer name, destination and shipping paperwork. Such information may be received wirelessly as through the use of radio frequency identification attached to, or embedded in the cargo. Movement of the RFID tag within a scanning zone of an associated sensor will cause the sensor to retrieve the product information. Other wireless devices such as bar code readers, PDAs, PC tablets and laptops are also possible. Depending on the type of information to retrieve, such information can be received by the server 15 by way of sensors such as the aforementioned cameras, temperature sensors, humidity sensors, chemical sensors, radiology sensors, location sensors, accelerometers, smoke detectors, and tamper evidence sensors, all of which can either be wired, or wirelessly connected to the server 15. The server 15 may receive the information using known file transfer protocols over a TCP/IP (transmission control protocol over Internet protocol) network. Other protocols include, but are not limited to, HTTP, FTP, SMTP, UDP, ECHO, SSH, TELNET, NAMESERVER, BOOT PS, BOOT PC, TFTP, KERBEROS, POP3, NNTP, IMAP, SNMP, BGP, IMAP3, LDAP, and HTTPS.

During transit of the container 11 from the origin to the destination, the sensors could operate periodically to detect conditions. For example, the sensor could measure the temperature within the shipping container 11. Although described as being at the initiation of the server 15 (i.e. the server 15 acts as the client in a client/server relationship), the present invention also allows an individual at a remote location to command the server 15 to measure a condition with the sensor (i.e. the server 15 acts as the server in a client/server relationship). For example, the individual could turn on the camera 17 to view the interior of the shipping container 11 at any time.

At the initiation of the server 15 (e.g., periodically or upon reaching the destination) or of an individual from a remote location, the server 15 provides any information obtained by the sensor to the Internet. Individuals located near the container 11 could obtain such information directly from the server 15 (rather than the Internet) using the communications port 21 or wireless access (e.g., antenna 23).

Regardless of the manner obtained, the shipper can review the information provided by the server 15 to determine how to handle the shipping container 11. As an example, the shipper could subject an engine to a detailed inspection if the information indicated the presence of an unsuitable condition (e.g., excessive humidity) in the container 11. Likewise, the shipper could subject the engine to a rudimentary visual inspection if the information did not indicate any unsuitable conditions.

A discussion of another possible use of the present disclosure follows. This time, the shipping container 11 can contain any type or quantity of product. At the origin, the server 15 receives information related to the products within the container. This information could include, for example, the bill of lading, customs paperwork and other shipping documents. Such information may be received wirelessly as though the use of radio frequency identification attached to, or embedded in the cargo. Movement of the RFID tag within a scanning zone of an associated sensor will cause the sensor to retrieve the product information. Other wireless sensors such as bar code readers are also possible. Depending on the type of information to retrieve, such information can be received by the server 15 by way of sensors such as the aforementioned cameras, temperature sensors, humidity sensors, chemical sensors, radiology sensors, location sensors, accelerometers, smoke detectors, and tamper evidence sensors, all of which can either be wired, or wirelessly connected to the server 15. The server 15 may receive the information using known file transfer protocols over a TCP/IP (transmission control protocol over Internet protocol) network. Other protocols include, but are not limited to, HTTP, FTP, SMTP, UDP, ECHO, SSH, TELNET, NAMESERVER, BOOT PS, BOOT PC, TFTP, KERBEROS, POP3, NNTP, IMAP, SNMP, BGP, IMAP3, LDAP, and HTTPS.

A designated individual, such as a customs employee, seals the container 11 at the origin and arms the server 15. During transit, the sensors preferably operate periodically to detect conditions. Alternatively, the sensor could be passive, only notifying the server 15 upon a given condition. For example, the sensors could detect tampering with the container 11 (e.g., open container door) or conditions with the container 11 (e.g., movement). Although described as being at the initiation of the server 15, the present disclosure also allows an individual at a remote location to command the server 15 to measure these conditions with the sensors. For example, the individual could turn on the camera 17 to view the interior of the shipping container 11.

At the initiation of the server 15 (e.g., periodically or upon reaching the destination) or of an individual from a remote location, the server 15 provides any information obtained by the sensor to the Internet. Individuals located near the container 11 could obtain such information directly from the server 15 (rather than the Internet) using the communications port 21 or wireless access (e.g., antenna 23).

Regardless of the manner obtained, the customs employee can review the information provided by the server 15 to determine how to handle the shipping container 11. As an example, the customs agent could subject the container 11 to a detailed inspection if the information indicated the presence of an unsuitable condition (e.g., tampering) with respect to the container 11. Likewise, the customs employee could allow the container 11 to pass without inspection if the information did not indicate any unsuitable conditions. Furthermore, the customs employee could determine the level of inspection based upon the type or quantity of products that the server 15 identifies as being contained within the shipping container 11. Such inspection, or testing, diagnostics, and like can also be initiated from a remote location as the server 15, by way of the Internet is connected to the remote locations.

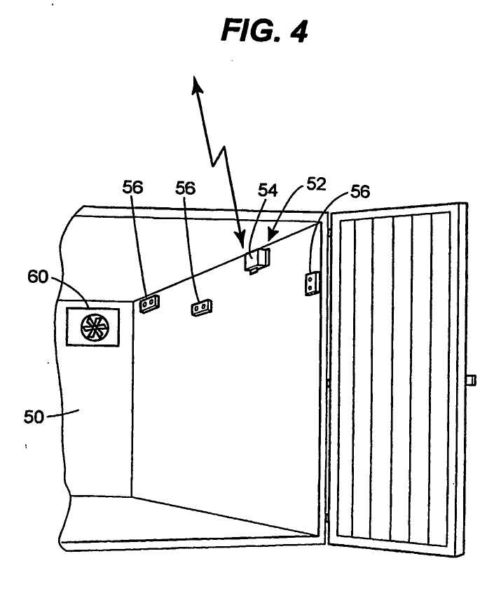

FIG. 4 displays another embodiment of a shipping container 50. The shipping container 50 is a mobile asset that can receive any type of product or any number of products. In fact, the term “shipping container” could refer to any cargo container such as a railroad box car, maritime container or over-the-road trailer.

The shipping container 50 includes a monitoring system 52. Although shown in FIG. 4 as located in the interior, the system 52 could be located at any suitable location on the container 50. The system 52 includes a computer server 54. The server 54 could be any known computer or processing unit. Preferably, however, the server 54 is a hand-held microsever using a Linux-based operating system. Further, the server 54 may have its own web address, firewall and security protocols.

The server 54 may monitor the conditions in or near the shipping container 50 and/or gather data about the products within or near the container 50. To perform these tasks, the server 54 may interact with one or more sensors 56. Preferably, the sensors 56 utilize wireless connectivity to communicate with the server 54. However, the sensors 56 could be hard wired or removably connected to the server 54. Examples of suitable sensors include cameras (video or still), environmental sensors (e.g., temperature, humidity), chemical sensors, radiological sensors, location sensors (e.g., GPS), accelerometers, smoke detectors, and sensors to detect tampering with the container 50 (e.g., contact switches to indicate opening of the container 50, and motion detectors).

The value and origination of the products within the container 50 could also help determine the suite of sensors placed within the container. For example, a container of clothing may have a simple suite of sensors such as an electronic lock, a log of opening and closing of doors, and a temperature sensor. A container of perishable items could have a full suite of sensors providing electronic locks, a log of door opening/closing, environmental conditions. The suite of sensors could also indicate the condition of the refrigeration unit 60. Other types of cargo may demand various other specialized sensors (e.g., radiation).

The server 54 can communicate with the Internet or World Wide Web in two modes. The first mode directly communicates with the Internet or World Wide Web using cellular, satellite or wireless communications. The first mode is preferably used when the container 50 is a discrete unit, such as an over-the-road truck hauling a single container 50.

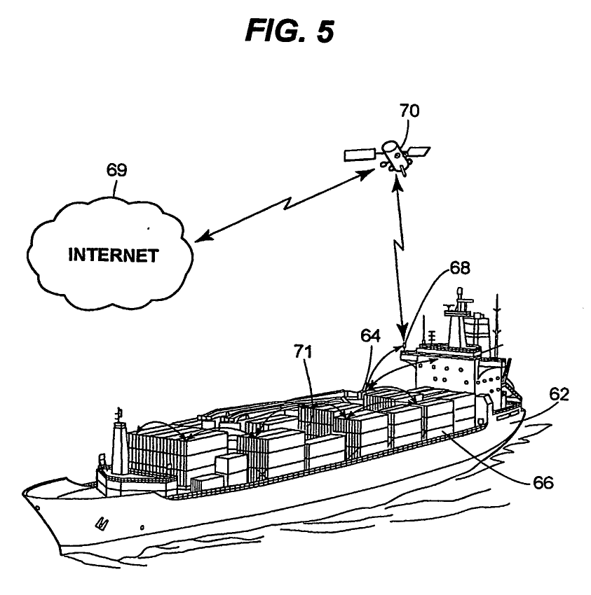

The second mode indirectly communicates with the Internet or Would Wide Web. The second mode is preferably used when the presence of more than two containers exist (for example the containers 50 on a transport vessel like the ship 62 in FIG. 5). The second mode is an automated, wireless, low power network that allows data relay/access between containers (even the most inaccessible containers 50 on the ship 62). A “shepherd” microserver unit on one container 64 would then be the master coordinator unit for the “flock” of the remaining containers 50. The container 64 with the “shepherd” microsever would use the first mode of communication described above, while containers 66 with the “flock” microservers need only have communications gear sufficient to reach adjacent containers. Each transport vessel would have at least one shepherd unit 64 to coordinate with the remaining containers 66 and to provide a more robust Internet access feed. Alternatively, the shepherd container 64 could utilize existing communicating gear 68 on the transport vessel 62 to communicate with the Internet or World Wide Web 69 by way of satellite 70 or the like, as shown in FIG. 5. The shepherd container could be only partially occupied by the necessary electronics, thus leaving the remainder available for storage, and camouflage of the electronics.

This highly flexible approach allows the microserver-equipped container 50, like a packet of data on the Internet, to have its own “awareness.” That allows the container 50 to know the “who what when where and why” of its contents and destination. More importantly, it can process onboard software with sensors that can then be remotely reported or accessed individually, or leapfrogging encrypted information from unit to unit to the Internet and the appropriate portal location. Data such as security breach, log of opening and closing the doors, bill of lading, owner, routing and destination can be accessed both locally or shipboard with a PDA, and remotely by linking these units wirelessly to a single point of communications for Internet access.

Another aspect of the present disclosure is the use of a surveillance container 71. The container 71 is preferably shipped alongside ordinary containers 64, 66. The container 71 would include an array of sophisticated sensors that could sense conditions on nearby containers 64, 66. Preferably not carrying cargo, the container 71 could have a power supply (not shown) sufficient to power the sophisticated sensors throughout the journey. Alternatively, if a refrigerated container, such units often include their own power supply which can be used to power the surveillance electronics. The existing power supply of the cargo ship or other transporting vehicle can also be used.

The container 71 could also assist the “flock” containers 64 communicate with the “shepherd” container 641 by relaying the data (as described in the second mode of communication above). That could allow the container 71 to review the sensor data from the other containers 64, 66 for anomalies. Preferably, the presence of the container 71 is unknown to the shipper. Ideally, the shipper believes the container 71 is a normal container 64, 66.

Upon reaching the destination (or perhaps earlier), the surveillance container 71 could notify relevant personnel of possible hazardous or anomalous conditions, or that the situation appears normal. Depending on the notification from the container 71, customs personnel could place a hold on the containers 64, 66 (for hazardous/anomalous conditions) or grant immediate release of the containers 64, 66 (for normal conditions).

The use of the microserver also has other benefits. The microserver allows better management of the supply chain, prevents loss or spoilage of products during shipment, possibly reduces insurance rates on the container, assists with insurance claims/adjustments, etc. The microserver may also include an antenna or transmitted for use by a GPS (global positions satellite) or other location finder to enable the exact location of the container to be identified.

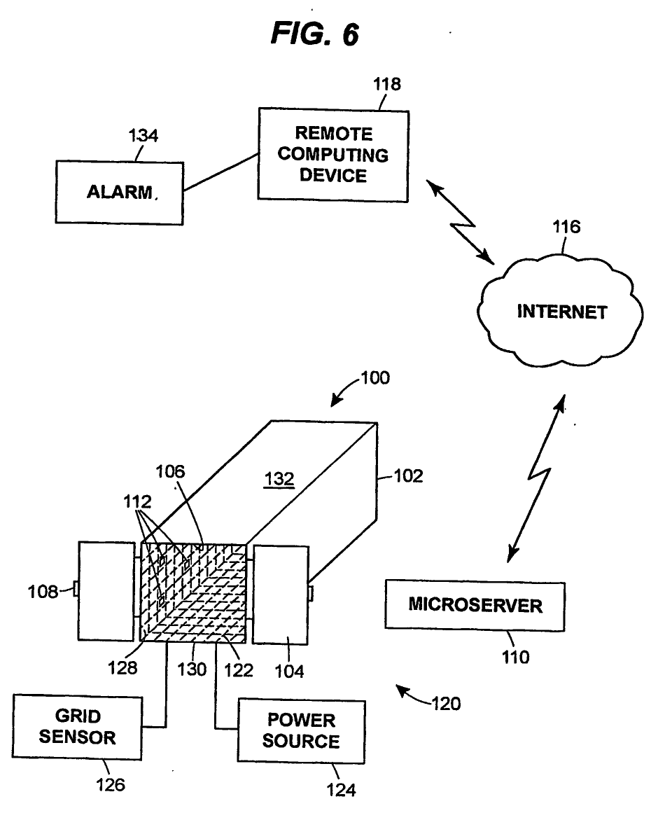

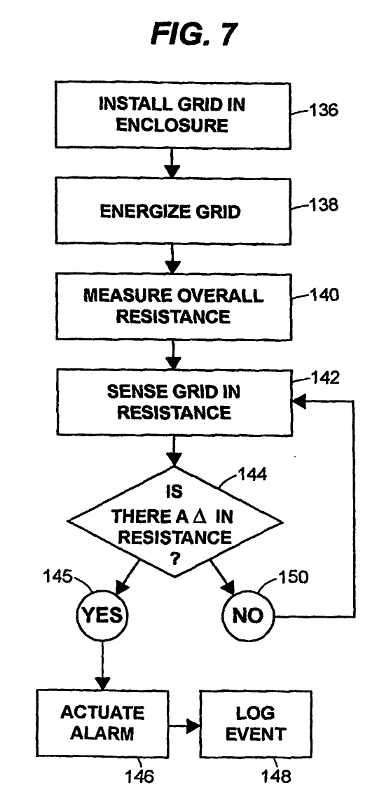

Referring now to FIGS. 6 and 7, a third embodiment of a shipping container constructed in accordance with the teachings of the disclosure is generally referred to by reference numeral 100. As shown therein, the container 100 includes an enclosure 102 having doors 104 adapted to open and close an opening 106 through which a product (not shown) can be loaded and unloaded from the enclosure 102. The doors 104 may be provided with locks 108 to provide the enclosure 102 with security provisions.

As with the previously identified embodiments, the enclosure 102 includes a microserver 110 in communication with a plurality of sensors 112 provided within the enclosure 102. As above, the sensors 112 can be provided to measure any type of parameter within the enclosure including, but not limited to, temperature, humidity, chemical concentrations, radiation, proximity, speed, acceleration, smoke, and the like. In addition, one or more of the sensors 112 may be provided in the form of a video camera (still or motion) to provide a remote location 114 with a video feed by way of the Internet 116 and a computing device 118.

As will be readily understood by any one of ordinary skill in the art, the communication between the server 110 and the Internet 116 can be accomplished wirelessly by way of a satellite, local area network, cellular network or the like. In addition, one of ordinary skill in the art will also understand that the computing device 118 can be provided in the form of any number of different devices including, but not limited to desktop computers, laptop computers, wireless PC tablets, personal digital assistants, cellular phones, and the like. As with the aforementioned embodiments, the microserver 110 may host its own web page and thereby server as a distinct node or web address on the world wide web and the access through the Internet by way of any of the computing devices 118. In so doing, the user of the system can be anywhere in the world such as at a manufacturing facility, warehouse, a distribution center, or a residence and once accessing the web page hosted by the microserver 110, be immediately provided with the information being sensed and communicated to the microserver 110.

A difference with respect to the previous described embodiments however, is the provision of an anti-tampering system 120 as shown in FIG. 6, the system 120 may include a conductive grid 122 connected to a power source 124 and provided with an electrical parameter sensor 126. The conductive grid 122 can be provided within the enclosure 102 in a number of different ways including, but not being limited to, being imbedded directly within the enclosure walls 102, attached to an interior surface 128 of the enclosure 102, or painted onto or otherwise adhered to the interior surface 128. For example, while not depicted, the conductive grid 122 can be provided within a floor 130 of the enclosure 102 by machining grooves (not shown) into the floor 130 and then embedding the conductive grid 122 into the grooves. In the case of a wood floor 130, as is typical with such containers 100, the grooves can of course be routed or sawn into the wood with the conductive grid, i.e., wires, then being embedded into the grooves. Similarly, with respect to walls 132 they are typically manufactured from metal or insulative materials as in the case of refrigerated enclosures 102, such that the conductive grid 122 can be embedded therein.

Once the conductive grid 122 is so provided and energized by the power source 124, i.e., by directing current therethrough, a number of advantageous features are provided. First, by directing current through the conductive grid 122, the conductive grid 122 forms a cage sometimes referred to as a Faraday cage within the enclosure 102. Such a cage greatly improves signal/noise ratio of the sensors 112 within the enclosure 102 by insulating the interior of the enclosure 102 from extraneous radio frequency noise. When extraneous radio frequency signals come into contact with the case, they are evenly distributed throughout the conductive material of the grid 122 without reaching its interior space. The microserver 110 can then flood the interior of the container 102, picking up signals reflected back by passive RFID sensors provided on the product without outside interference.

Secondly, from an intrusion detection perspective, if anyone were to intrude or otherwise tamper with the enclosure 102, electrical parameters of the conductive grid 122 will necessarily be affected which can be identified by the electrical parameter sensor 126 and communicated to the microserver 110. Once noticed, the microserver 110 and/or the computing device 118 can actuate an alarm or otherwise notify personnel to take corrective actions. At the very least, a log of the event can be created for historical tracking and identification of the intruder.

Referring now to FIG. 7, a sample flow chart depicting a possible set of steps which can be taken by the disclosure is identified. In the identified example, the electrical parameter sensor 126 is a resistance sensor, or ohmmeter. By knowing the overall resistance of the conductive grid 122 once energized, if someone were to interfere or tamper with the conductive grid 122, such as by cutting one of the conductors of the grid, the overall resistance of the grid 122 will necessarily change. The change in resistance will be detected by the microserver 110 and/or the computing device 118 whereupon the alarm 134 can be actuated. In alternative embodiments, the electrical parameter can be current, voltage, and the like.

As a result, with respect to FIG. 7, it will be noted that a first step will be to energize to install the conductive grid 122 within the enclosure 102. This is identified by a step 136. Once installed, the power source 124 is connected to the grid and thereby energizes the grid 122 as indicated by a step 138. Once energized, the overall resistance of the conductive grid 122 can be measured as indicated by a step 140 to thereby provide a baseline or desired level of resistance. After being deployed, the resistance of the conductive grid 122 can be periodically sensed on any desired interval ranging from minutes to nanoseconds as indicated by a step 142, after which, desired and actual levels of resistance are known. The two can then be compared as by the computing device 118 in a step 144, and if any difference, delta, is identified in a step 145, the alarm 134 can be actuated as indicated by a step 146 and a log of the event (step 148) can be created. Alternatively, if no delta or change in resistance is detected as indicated by a step 150, the system or method can return to sensing the conductive grid resistance step 142 to continue the process.

The present disclosure has been described in connection with the preferred embodiments of the various figures. It is to be understood that other similar embodiments may be used or modifications and additions may be made to the described embodiment for performing the same function of the present disclosure without deviating therefrom. Therefore, the present invention should not be limited to any single embodiment, but rather construed in breadth and scope in accordance with the recitation of the appended claims.

1-56. (canceled)

57. A shipping container, comprising:
an enclosure for receiving at least one product;
a sensor on the enclosure capable of detecting a condition;
a server on the enclosure communicating with the sensor, the server hosting a web page; and
means for enabling communications between the server web page and a remote location by way of the Internet.

58. The shipping container of claim 57, wherein the sensor is an environmental sensor.

59. The shipping container of claim 57, wherein the sensor detects tampering with the enclosure.

60. The shipping container of claim 57, wherein the sensor is a location sensor.

61. The shipping container of claim 57, wherein the sensor is a camera.

62. The shipping container of claim 57, wherein the enclosure is a gas turbine engine enclosure.

63. The shipping container of claim 57, further including a conductive grid operatively associated with an interior surface of the enclosure and a grid sensor monitoring an electrical parameter of the grid, the grid sensor communicatively coupled to the server.

64. The shipping container of claim 63, wherein the grid sensor is resistance sensor.

65. The shipping container of claim 57, wherein the sensor on the enclosure detects conditions of other shipping containers.

66. The shipping container of claim 65, wherein the sensor is selected from the group of sensors consisting of video sensors, environmental sensors, chemical sensors, radiological sensors, location sensors, acceleration sensors, smoke sensors, and tampering sensors.

67. The shipping container of claim 57, further including a conductive grid operatively associated with an interior surface of the enclosure and a sensor adapted to measure the electrical resistance of the grid, the sensor communicating with the server.

68. The shipping container of claim 57, further including:
a conductive grid operatively associated with the enclosure;
a power source connected to the conductive grid and adapted to energize the conductive grid,
wherein the sensor on the enclosure is adapted to monitor a condition associated with the conductive grid.

69. The shipping container of claim 68, wherein the conductive grid is metallic mesh mounted on an interior surface of the enclosure.

70. The shipping container of claim 68, wherein the conductive grid is embedded in an interior surface of the enclosure.

71. The shipping container of claim 68, wherein the conductive grid is painted on an interior surface of the enclosure.

72. The shipping container of claim 68, wherein the conductive grid includes a first insulating layer, a metallic paint layer over the first insulating layer, and a second insulating layer over the metallic paint layer.

73. The shipping container of claim 68, further including a refrigeration unit.

74. The shipping container of claim 68, wherein the sensor monitors electrical resistance within the grid.

75. The shipping container of claim 68, further including a second sensor within the enclosure and adapted to monitor a parameter associated with the product.

76. The shipping container of claim 68, wherein the second sensor communicates wirelessly with a radio-frequency identification tag associated with the product.

77. The shipping container of claim 68, further including:
a remote computing device adapted to wirelessly communicate with the server by way of the Internet, and
wherein the server is further adapted to generate a wireless system about the enclosure.

78. A method of monitoring a shipping container, comprising the steps of:
providing a shipping container, said shipping container including an enclosure for receiving at least one product, a sensor on the enclosure, a server on the enclosure hosting a web page and communicating with the sensor, and means for enabling communications between the server and a remote location by way of the Internet;
detecting a condition with the sensor during transit between an origin and a destination;
communicating between the server and the remote location in response to the condition, either during the transit or at the destination; and
determining whether the condition is an unacceptable condition.

79. The method of claim 78, wherein said detecting step comprises detecting an environmental condition.

80. The method of claim 78, wherein said detecting step detects tampering with the enclosure.

81. The method of claim 78, wherein the detecting step detects a location.

82. The method of claim 78, wherein the sensor is a camera.

83. The method of claim 78, wherein the container is a gas turbine engine container.

84. The method of claim 78, wherein the server initiates said communicating step.

85. The method of claim 78, wherein the remote location initiates said communicating step.

86. The method of claim 78, further comprising the steps of:
supplying the server, before transit between an origin and a destination, with information related to the at least one product;
communicating between the server and the remote location, in response to the information, either during transit between the origin and the destination or at the destination; and
determining, in response to the information, how to handle the shipping container.

87. The method of claim 86, wherein the sensor detects a condition during transit, the determining step determining how to handle the shipping container in response to the information or the condition.

88. The method of claim 86, wherein the server initiates the communication step.

89. The method of claim 86, wherein the remote location initiates the communicating step.

90. The method of claim 86, further including the steps of providing a conductive grid within the enclosure, monitoring an electrical parameter of the conductive grid, and actuating an alarm if the electrical parameter changes.

91. The method of claim 86, wherein the electrical parameter is resistance.

92. The method of claim 90, further comprising:
energizing a conductive grid provided within an enclosure;
sensing a condition associated with the conductive grid;
communicating the sensed condition to the server; and
transmitting the sensed condition from the server to a remote location.

93. The method of claim 92, wherein the sensing step monitors electrical resistance within the conductive grid.

94. The method of claim 92, further including the step of attaching the conductive grid to an inner surface of the enclosure.

95. The method of claim 92, further including the step of paining the conductive grid onto an inner surface of the enclosure.

96. The method of claim 92, further including the step of embedding the conductive grid in an inner surface of the enclosure.

97. The method of claim 92, wherein the communicating step is performed wirelessly.

98. The method of claim 92, wherein the transmitting step is performed wirelessly.

99. The method of claim 92, further including the step of detecting an intrusion into the enclosure when the sensed condition changes.

100. The method of claim 92, further including the step of actuating an alarm when an intrusion is detected.
